(19) United States
(12) Patent Application Publication
(10) Pub. No.: US 2026/0063161 A1
(43) Pub. Date: Mar. 5, 2026

(54) FASTENING DEVICES

(71) Applicant: RTG Scientific, LLC, Austin, TX (US)

(72) Inventors: Richard Justin Hyer, Hyrum, UT (US); Nicholas William Medendorp, JR., Carmel, IN (US)

(21) Appl. No.: 18/821,762

(22) Filed: Aug. 30, 2024

(51) Int. Cl. F16B 25/00

(52) U.S. Cl. CPC F16B 25/0068

(57) ABSTRACT

A fastener to resist loadings in multiple directions simultaneously is provided. The fastener utilizes multiple thread faces that extend outward from the center axis of the fastener in various directions.

### BACKGROUND

### Field of the Disclosure

The disclosure relates generally to fastening devices. More specifically, the present disclosure relates to fastening devices with improved thread designs.

### Description of the Related Art

Numerous thread forms/thread shapes have been utilized on fasteners to provide performance characteristics for their intended use. Buttress threads are used to apply or resist actual load; Acme threads are utilized in situations where strength is needed to drive linear motion along the fastener; v-threads are commonly used in bolts/nuts; and machine fasteners fasten objects together via compression created by the thread.

### SUMMARY

The various fastening devices of the present disclosure have been developed in response to the present state of the art, and in particular, in response to the problems and needs in the art that have not yet been fully solved by currently available fastening devices.

Innovative aspects of the subject matter described in this specification may be embodied in a fastener including: a shaft; a first thread pattern extending from the surface, the first thread pattern including a first top surface and a first bottom surface, wherein the first top surface is angled with respect to the shaft, wherein the first bottom surface is normal to the shaft; and a second thread pattern extending from the surface, the second thread pattern including a second top surface and a second bottom surface, wherein the second top surface is normal to the shaft and the second bottom surface is angled with respect to the shaft, wherein the first top surface of the first thread pattern and the second bottom surface of the second thread pattern form a first valley therebetween, wherein the first bottom surface of the first thread pattern and the second top surface of the second thread pattern form a second valley therebetween.

These and other embodiments may each optionally include one or more of the following features. For instance, the first top surface of the first thread pattern is angled with respect to the shaft at a first angle, the second bottom surface of the second thread pattern is angled with respect to the shaft at a second angle. The first angle and the second angle are the same angle. The first angle and the second angle are both greater than 90 degrees. The first valley is associated with a first width, and the second valley is associated with a second width. The first width is greater than the second width. The first top surface of the first thread pattern is adjacent to the second bottom surface of the second thread pattern. The first bottom surface of the first thread pattern is adjacent to the second top surface of the second thread pattern.

Innovative aspects of the subject matter described in this specification may be embodied in a fastener including: a shaft; a first thread pattern extending from the surface, the first thread pattern including a first top surface and a first bottom surface, wherein the first top surface is angled with respect to the shaft, wherein the first bottom surface is angled with respect to the shaft; and a second thread pattern extending from the surface, the second thread pattern including a second top surface and a second bottom surface, wherein the second top surface is angled with respect to the shaft and the second bottom surface is angled with respect to the shaft, wherein the first top surface of the first thread pattern and the second bottom surface of the second thread pattern form a first valley therebetween, wherein the first bottom surface of the first thread pattern and the second top surface of the second thread pattern form a second valley therebetween.

These and other embodiments may each optionally include one or more of the following features. For instance, the first top surface of the first thread pattern is angled with respect to the shaft at a first angle, the first bottom surface of the first thread pattern is angled with respect to the shaft at a second angle, the second top surface of the second thread pattern is angled with respect to the shaft at a third angle, the second bottom surface of the second thread pattern is angled with respect to the shaft at a fourth angle. The first angle and the fourth angle are the same angle. The first angle and the fourth angle are both greater than 90 degrees. The second angle and the third angle are the same angle. The second angle and the third angle are both less than 90 degrees. The first valley is associated with a first width, and the second valley is associated with a second width. The first width is greater than the second width. The first top surface of the first thread pattern is adjacent to the second bottom surface of the second thread pattern. The first bottom surface of the first thread pattern is adjacent to the second top surface of the second thread pattern.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a perspective view of a threaded fastener.

FIG. 2A illustrates a front perspective view of a fastener.

FIG. 2B illustrates a rear perspective view of the fastener of FIG. 2A.

FIG. 2C illustrates a side view of the fastener of FIG. 2A.

FIG. 2D illustrates a cross-sectional side view of the fastener of FIG. 2A taken along the line A-A shown in FIG. 2C.

FIG. 3 is a perspective view of a fastener along a side thereof.

FIGS. 4A, 4B, 4C illustrate a thread pattern of a fastener, in a first implementation.

FIGS. 5A, 5B, 5C illustrate a thread pattern of a fastener, in a second implementation.

### DESCRIPTION OF PARTICULAR EMBODIMENT(S)

This disclosure relates generally to fastening devices.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Exemplary embodiments of the present disclosure will be best understood by reference to the drawings, wherein like parts are designated by like numerals throughout. It will be readily understood that the components of the present disclosure, as generally described and illustrated in the drawings, could be arranged, and designed in a wide variety of different configurations. Thus, the following more detailed description of the embodiments of the implants, systems, and methods, as represented in the drawings, is not intended to limit the scope of the present disclosure, but is merely representative of exemplary embodiments of the present disclosure.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in the drawings, the drawings are not necessarily drawn to scale unless specifically indicated.

In some examples, the following disclosure presents various fasteners for utilization in bone and other tissues as implantable devices (e.g., orthopedic implants, spine implants, sports medicine implants, dental implants, trauma implants, reconstruction implants, extremity implants, craniomaxillofacial (CMF) implants, veterinary implants, etc.) for the purpose of streamlining the present disclosure. However, it will be understood that the various fasteners and helical threading concepts presented herein can be utilized in any medium beyond bones/tissues and/or for any application beyond surgical procedures.

Example applications/procedures that may utilize any of the fasteners described or contemplated herein, in any configuration and with any of the features described herein, may include, but are not limited to: trauma procedures, spine procedures (e.g., SI fusion, facet fixation, etc.), reconstruction procedures, sports related procedures, ACL/tenodesis procedures, extremity procedures, dental procedures, CMF procedures, veterinary procedures, fracture fixation plate procedures (e.g., distal femur plates, proximal humerus plates, tibial plates, etc.), supplemental Fixation for IBD procedures, intramedullary canal fixation procedures, nail fixation procedures, limb salvage and transfemoral procedures, amputee connection procedures, total shoulder fixation, reverse glenoid fixation, small bone fixation (e.g., podiatric, hand/wrist, etc.), joint fusions, single-tooth implant fixation, jaw/facial reconstruction, dentures fixation, veterinary trauma, species specific procedures (e.g., equine, canine, rabbit, etc.), TPLO, shear fixation, osteotomies, fusions, procedures involving osteoporotic or compromised bone, etc.

Moreover, fastener types that may utilize any of the thread designs, morphology, and/or features described herein may include, but are not limited to: cortical fasteners, soft tissue fasteners, long fasteners, cannulated fasteners, plate fasteners, locking/non-locking fasteners, dynamic hip fasteners, acetabular cup fasteners, Schanz pins, half pins, pedicle fasteners, cervical fasteners, threaded stems, threaded intramedullary canal stems, joint stems, revision fasteners, compression fasteners (e.g., headless/headed compression fasteners, hip compression fasteners, etc.), ACL fasteners, tenodesis fasteners, bone-tendon-bone graft fasteners, suture anchors, dental fasteners, mandibular tenting fasteners, veterinary fasteners, etc.

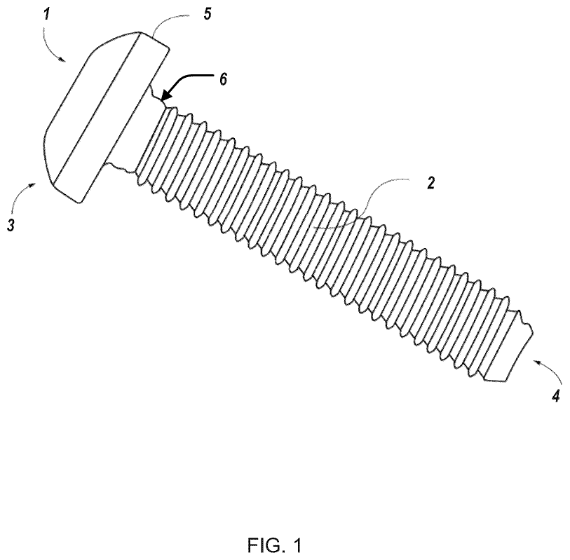

Particular embodiments are best understood by reference to FIGS. 1-6 wherein like numbers are used to indicate like and corresponding parts.

Referring to FIG. 1, a threaded fastener 1 includes a threaded portion 2 extending from a first end 3 to a second end 4. The second end 4 may alternatively be referred to as the lead end of the fastener based upon the driving direction of the fastener. In some embodiments, the threaded fastener 1 is a screw having a head 5. The threaded portion 2 is defined by a helical thread extending around an elongated shank 6 that extends from the head 5 to the second end 4. The thread can be defined by at least a crest portion, a leading flank, a root portion, and a trailing flank. The configuration of the thread may be defined by reference to a longitudinal axis and/or a normal axis of the threaded fastener. The longitudinal axis extends through the fastener from the first end to the second end, whereas the normal axis extends perpendicular to the longitudinal axis.

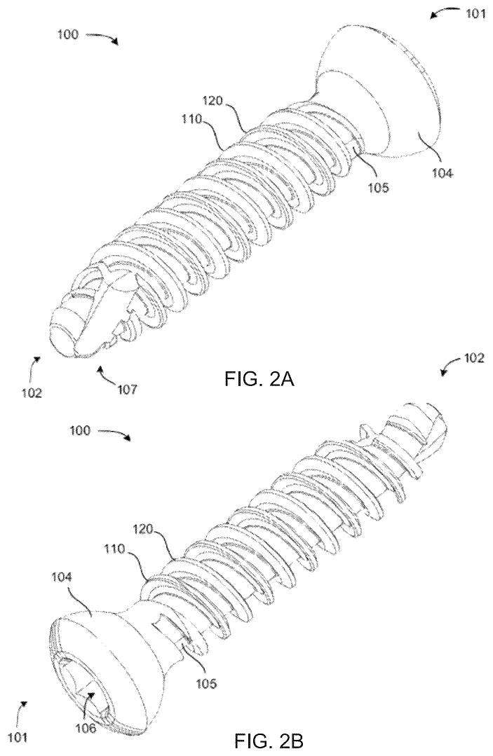

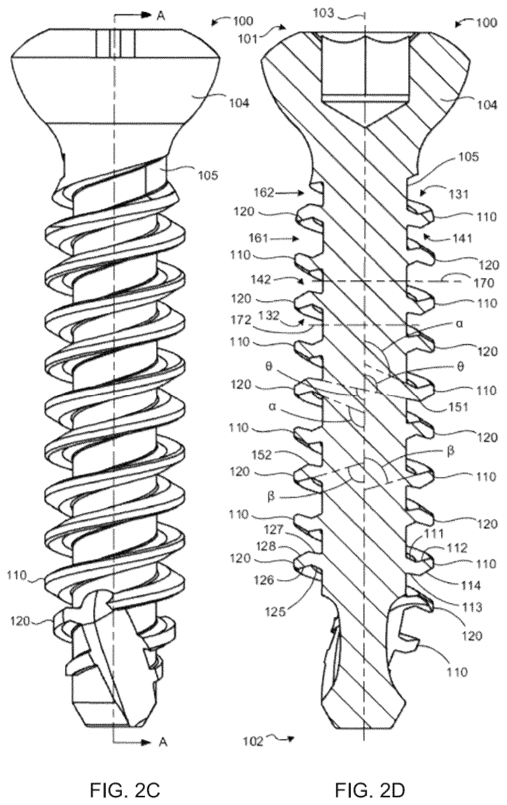

FIGS. 2A-D illustrate an example of the threaded fastener 1 of FIG. 1, and in particular, illustrate various views of a fastener 100, implantable bone anchor, or bone screw, according to one embodiment of the present disclosure. Specifically, FIG. 2A is a front perspective view of the fastener 100, FIG. 2B is a rear perspective view of the fastener 100, FIG. 2C is a side view of the fastener 100, and FIG. 2D is a cross-sectional side view of the fastener 100 taken along the line A-A in FIG. 2C.

In general, the fastener 100 may include a shaft 105 having a proximal end 101, a distal end 102, and a longitudinal axis 103. The fastener 100 may also include a head 104 located at the proximal end 101 of the shaft 105, a torque connection interface 106 formed in/on the head 104 (in either a male/female configuration), and a self-tapping feature 107 formed in the distal end 102 of the shaft 105.

In some embodiments, the fastener 100 may include a first helical thread 110 disposed about the shaft 105, and a second helical thread 120 disposed about the shaft 105 adjacent the first helical thread 110.

In some embodiments, the fastener 100 may include a “dual start” or “dual lead” thread configuration comprising the first helical thread 110 and the second helical thread 120.

In some embodiments, a depth of the first helical thread 110 and/or the second helical thread 120 with respect to the shaft 105 may define a major diameter vs. a minor diameter of the shaft 105 alone.

In some embodiments, a major diameter and/or a minor diameter of the fastener 100 may be constant or substantially constant along the entire length of the fastener, or along a majority of the length of the fastener. In these embodiments, a constant minor diameter may help avoid blowout of narrow/delicate bones (e.g., a pedicle) when inserting a fastener into a bone. In some embodiments, a pilot hole may first be drilled into a narrow/delicate bone and then a fastener having a similar minor diameter in comparison to the diameter of the pilot hole may be chosen to avoid blowout when inserting the fastener into the bone.

In some embodiments, a depth of the first helical thread 110 and/or the second helical thread 120 with respect to the shaft 105 may vary along a length of the shaft 105 to define one or more major diameters of the fastener 100 and/or one or more regions along the fastener 100 may comprise a one or more continuously variable major diameters.

In some embodiments, a thickness of the shaft 105 may vary along a length of the shaft 105 to define one or more minor diameters of the fastener 100, and/or one or more regions along the fastener 100 may comprise one or more continuously variable minor diameters. In some embodiments, a thickness/height/width/length/pitch/shape of the first helical thread 110 and/or the second helical thread 120 (or any additional helical thread) may vary along a length of the shaft 105. For example, a thickness/height/width/length/pitch/shape of the first helical thread 110 and/or the second helical thread 120 may be greater towards the tip of the fastener and thinner towards the head of the fastener (or vice versa) in either a discrete or continuously variable fashion, etc.

In some embodiments, the major and/or minor diameters may increase toward a proximal end or head of a fastener in order to increase bone compaction as the fastener is terminally inserted into the bone/tissue.

In some embodiments, a pitch of the first helical thread 110 and/or the second helical thread 120 may vary along a length of the fastener 100.

In some embodiments, the fastener 100 may include a plurality of helical threads disposed about the shaft 105. However, it will also be understood that any of the fasteners disclosed or contemplated herein may include a single helical thread disposed about the shaft of the fastener. Moreover, the fastener 100 may comprise a nested plurality of helical threads having different lengths (not shown). As one non-limiting example, the fastener 100 may include a first helical thread 110 that is longer than a second helical thread 120, such that the fastener 100 comprises dual threading along a first portion of the shaft 105 and single threading along a second portion of the shaft 105.

In some embodiments, the plurality of helical threads may include three helical threads (not shown) comprising a “triple start” or “triple lead” thread configuration (not shown).

In some embodiments, the plurality of helical threads may include four helical threads (not shown) comprising a “quadruple start” or “quadruple lead” thread configuration (not shown).

In some embodiments, the plurality of helical threads may include more than four helical threads (not shown).

In some embodiments, the fastener 100 may include first threading with any of the shapes disclosed herein oriented toward one of the proximal end and the distal end of the fastener 100 with the first threading located proximate the distal end of the fastener 100, as well as second threading with any of the shapes disclosed herein oriented toward the other one of the proximal end and the distal end of the fastener 100 with the second threading located proximate the head of the fastener 100 (not shown).

In some embodiments, the fastener 100 may include multiple threading (e.g., dual helical threading, etc.) with any of the shapes disclosed herein located proximate one of the proximal end and the distal end of the fastener 100, as well as single threading with any of the shapes disclosed herein with the second threading located proximate the other of the proximal end and the distal end of the fastener 100 (not shown).

In some embodiments, the first helical thread 110 may include a plurality of first concave undercut surfaces 131 and a plurality of first convex undercut surfaces 141.

In some embodiments, the second helical thread 120 may include a plurality of second concave undercut surfaces 132 and a plurality of second convex undercut surfaces 142.

In some embodiments, when the fastener 100 is viewed in section along a plane that intersects the longitudinal axis 103 of the shaft 105 (as shown in FIG. 2D), the plurality of first concave undercut surfaces 131 and the plurality of second convex undercut surfaces 142 may be oriented toward (i.e., point toward) the proximal end 101 of the shaft 105.

In some embodiments, the plurality of first convex undercut surfaces 141 and the plurality of second concave undercut surfaces 132 may be oriented toward (i.e., point toward) the distal end 102 of the shaft 105.

In some embodiments, at least one of the plurality of first concave undercut surfaces 131, the plurality of first convex undercut surfaces 141, the plurality of second concave undercut surfaces 132, and the plurality of second convex undercut surfaces 142 may comprise at least one substantially flat surface.

In some embodiments, when the fastener 100 is viewed in section along a plane intersecting the longitudinal axis 103 of the shaft 105, the first helical thread 110 may comprise a plurality of first bent shapes (comprising at least one surface that is angled relative to the longitudinal axis 103 of the shaft 105 and/or at least one undercut surface) with a plurality of first intermediate portions 151 that are oriented toward (i.e., point toward) the distal end 102 of the shaft 105. This may be referred to as “standard”threading, having a “standard” orientation.

In some embodiments, when the fastener 100 is viewed in section along a plane intersecting the longitudinal axis 103 of the shaft 105, the second helical thread 120 may comprise a plurality of second bent shapes (comprising at least one surface that is angled relative to the longitudinal axis 103 of the shaft 105 and/or at least one undercut surface) with a plurality of second intermediate portions 152 that are oriented toward (i.e., point toward) the proximal end 101 of the shaft 105. This may be referred to as “inverted” threading, having an “inverted” orientation.

In some embodiments, one or more helical threads may morph/transition between a standard orientation and an inverted orientation along a shaft of a fastener.

In some embodiments, at least one of the plurality of first concave undercut surfaces 131, the plurality of first convex undercut surfaces 141, the plurality of second concave undercut surfaces 132, and the plurality of second convex undercut surfaces 142 may comprise at least one curved surface.

As shown in FIG. 2D, the proximally-oriented and distally-oriented surfaces of the first helical thread 110 (i.e., the first concave undercut surfaces 131 and the first convex undercut surfaces 141 in the fastener 100 of FIG. 2D) may not have mirror symmetry relative to each other about any plane perpendicular to the longitudinal axis 103 of the fastener 100. Rather, the first concave undercut surfaces 131 and the first convex undercut surfaces 141 may be generally parallel to each other. The same may be true for the second helical thread 120, in which the second concave undercut surfaces 132 and the second convex undercut surfaces 142 do not have mirror symmetry relative to each other, but may be generally parallel to each other.

Conversely, as also shown in FIG. 2D, the proximally-oriented surfaces of the first helical thread 110 may have mirror symmetry relative to the distally-oriented surfaces of the second helical thread 120. Specifically, the first concave undercut surfaces 131 may have mirror symmetry relative to the second convex undercut surfaces 142 about a plane 170 that bisects the space between them, and lies perpendicular to the longitudinal axis 103.

Similarly, the distally-oriented surfaces of the first helical thread 110 may have mirror symmetry relative to the proximally-oriented surfaces of the second helical thread 120. Specifically, the second concave undercut surfaces 132 may have mirror symmetry relative to the first convex undercut surfaces 141 about a plane 172 that bisects the space between them, and lies perpendicular to the longitudinal axis 103.

This mirror symmetry may be present along most of the length of the first helical thread 110 and the second helical thread 120, with symmetry across different planes arranged between adjacent turns of the first helical thread 110 and the second helical thread 120 along the length of the longitudinal axis 103. Such mirror symmetry may help more effectively capture bone between the first helical thread 110 and the second helical thread 120, and may also facilitate manufacture of the fastener 100, as will be described in more detail below.

In some embodiments, when the fastener 100 is viewed in section along a plane intersecting the longitudinal axis 103 of the shaft 105, the first helical thread 110 may include at least one partial crescent shape that is oriented toward (i.e., points toward) the distal end 102 of the shaft 105 and/or the proximal end 101 of the shaft 105.

In some embodiments (not shown), when the fastener 100 is viewed in section along a plane intersecting the longitudinal axis 103 of the shaft 105, the first helical thread 110 may include at least one partial crescent shape that is oriented toward (i.e., points toward) the distal end 102 of the shaft 105, and the second helical thread 120 may include at least one partial crescent shape that is oriented toward (i.e., points toward) the proximal end 101 of the shaft 105.

In some embodiments (not shown), the first helical thread 110 may include a first plurality of partial crescent shapes that are oriented toward (i.e., point toward) the distal end 102 of the shaft 105, and the second helical thread 120 may include a second plurality of partial crescent shapes that are oriented toward (i.e., point toward) the proximal end 101 of the shaft 105.

In some embodiments (not shown), the first plurality of partial crescent shapes and the second plurality of partial crescent shapes may be arranged in alternating succession along the shaft 105 of the fastener 100.

In some embodiments, a fastener may have only standard threads or only inverted threads. The type of threads that are desired may depend on the type and/or magnitude of loads to be applied to the fastener. For example, a screw loaded axially away from the bone in which it is implanted may advantageously have a standard thread, while a screw loaded axially toward the bone in which it is implanted may advantageously have an inverted thread. A screw that may experience multi-axial loading and/or off-loading conditions may advantageously include at least one standard thread and at least one inverted thread in order to increase bone fixation and load sharing between a bone/fastener interface during multi-axial and off-loading conditions to reduce high bone strain and distribute multi-axial forces applied to the bone in a load-sharing, rather than load-bearing, configuration. Shear loads and/or bending moments may also be optimally resisted with any chosen combination of threading, threading morphology, and/or threading variations contemplated herein to optimally resist shear loads, bending moments, multi-axial loading, off-loading conditions, etc.

In some embodiments, fasteners with standard threads may be used in conjunction with fasteners with inverted threads in order to accommodate different loading patterns.

In some embodiments, a single fastener may have both standard and inverted threads, like the fastener 100. Such a combination of threads may help the fastener 100 remain in place with unknown and/or varying loading patterns.

In some embodiments, the geometry of the threading of a fastener (with standard and/or inverted threads) may be varied to suit the fastener for a particular loading scheme. For example, the number of threads, the number of thread starts, the pitch of the threading, the lead(s) of the threading, the shape(s) of the threading, any dimension(s) associated with the threading (e.g., any length(s)/width(s)/height(s) associated with the threading), the major diameter(s), the minor diameter(s), any angulation/angles associated with any surfaces of the threading, the “handedness” of the threading (e.g., right-handed vs. left-handed), etc., may be varied accordingly to suit any specific medium of installation, loading pattern, application, procedure, etc., that may be involved.

In some embodiments, the material(s) of any portion of a fastener described herein may include, but are not limited to metals (e.g., titanium, cobalt, stainless steel, etc.), metal alloys, plastics, polymers, PEEK, UHMWPE, composites, additive particles, textured surfaces, biologics, biomaterials, bone, etc.

In some embodiments, any of the fasteners described herein may include additional features such as: self-tapping features, locking features (e.g., locking threading formed on a portion of the fastener, such as threading located on or near a head of the fastener), cannulation, any style of fastener head (or no fastener head at all), any style of torque connection interface (or no torque connection interface at all), etc.

In some embodiments, a tap (not shown) may be utilized to pre-form threading herein in a bone according to any threading shape that is disclosed herein. In this manner, taps with any suitable shape may be utilized in conjunction with any fastener described or contemplated herein to match or substantially match the threading geometry of a given fastener.

In some embodiments, a minor diameter of the fastener may be selected to match, or substantially match, a diameter of a pilot hole that is formed in a bone to avoid bone blowout when the fastener is inserted into the pilot hole.

Additionally or alternatively, the type of threads and/or thread geometry may be varied based on the type of bone in which the fastener is to be anchored. For example, fasteners anchored in osteoporotic bone may fare better with standard or inverted threads, or when the pitch, major diameter, and/or minor diameter are increased or decreased, or when the angulation of thread surfaces is adjusted, etc.

In some embodiments, a surgical kit may include multiple fasteners with any of the different thread options described or contemplated herein. The surgeon may select the appropriate fastener(s) from the kit based on the particular loads to be applied and/or the quality of bone in which the fastener(s) are to be anchored.

Continuing with FIG. 2D, in some embodiments the first helical thread 110 may include a plurality of first undercut surfaces 111, a plurality of second undercut surfaces 112, a plurality of third undercut surfaces 113, and a plurality of fourth open surfaces 114.

In some embodiments, the second helical thread 120 may include a plurality of fifth undercut surfaces 125, a plurality of sixth undercut surfaces 126, a plurality of seventh undercut surfaces 127, and a plurality of eighth open surfaces 128.

In some embodiments one or more of the plurality of first undercut surfaces 111, the plurality of second undercut surfaces 112, the plurality of third undercut surfaces 113, the plurality of fourth open surfaces 114, the plurality of fifth undercut surfaces 125, the plurality of sixth undercut surfaces 126, the plurality of seventh undercut surfaces 127, and the plurality of eighth open surfaces 128 may comprise at least one flat or substantially flat surface.

In some embodiments, the plurality of first undercut surfaces 111, the plurality of third undercut surfaces 113, the plurality of sixth undercut surfaces 126, and the plurality of eighth open surfaces 128 may be angled towards the distal end 102 of the shaft 105.

In some embodiments, the plurality of second undercut surfaces 112, the plurality of fourth open surfaces 114, the plurality of fifth undercut surfaces 125, and the plurality of seventh undercut surfaces 127 may be angled towards the proximal end 101 of the shaft 105.

In some embodiments, when the fastener 100 is viewed in section along a plane that intersects the longitudinal axis 103 of the shaft 105 (as shown in FIG. 2D), the first helical thread 110 may include at least one chevron shape that is oriented toward (i.e., points toward) the distal end 102 of the shaft 105. Likewise, the second helical thread 120 may also include at least one chevron shape that is oriented toward (i.e., points toward) the proximal end 101 of the shaft 105.

In some embodiments, when the fastener 100 is viewed in section along a plane that intersects the longitudinal axis 103 of the shaft 105 (as shown in FIG. 2D), the first helical thread 110 may include a first plurality of chevron shapes that are oriented toward (i.e., point toward) the distal end 102 of the shaft 105. Likewise, the second helical thread 120 may include a second plurality of chevron shapes that are oriented toward (i.e., point toward) the proximal end 101 of the shaft 105.

In some embodiments, the first plurality of chevron shapes and the second plurality of chevron shapes may be arranged in alternating succession along the shaft 105 of the fastener 100, (e.g., see FIG. 2D).

In some embodiments, a plurality of first interlocking spaces 161 and a plurality of second interlocking spaces 162 may be formed between the first helical thread 110 and the second helical thread 120 along the shaft 105 of the fastener 100.

In some embodiments, the plurality of first interlocking spaces 161 may be formed intermediate the first concave undercut surfaces 131 and the second concave undercut surfaces 132.

In some embodiments, the plurality of second interlocking spaces 162 may be formed intermediate the first convex undercut surfaces 141 and the second convex undercut surfaces 142.

In some embodiments, the plurality of first interlocking spaces 161 may be larger in size than the plurality of second interlocking spaces.

In some embodiments, the plurality of first interlocking spaces 161 and the plurality of second interlocking spaces 162 may be shaped and/or configured to interlock with bone/other tissues received therein to increase fixation of the fastener 100 within the bone/other tissues and provide additional resistance against multi-axial forces that may be applied to the fastener 100 and/or the bone/other tissues.

In some embodiments, the plurality of second undercut surfaces 112 and the plurality of sixth undercut surfaces 126 may be angled toward each other to trap bone/other tissues within the plurality of first interlocking spaces 161 in order to increase fixation and resistance against multi-axial forces.

In some embodiments, the plurality of third undercut surfaces 113 and the plurality of seventh undercut surfaces 127 may be angled toward each other to trap bone/other tissues within the plurality of second interlocking spaces 162 in order to increase fixation and resistance against multi-axial forces.

In some embodiments, the plurality of first undercut surfaces 111 and the plurality of fifth undercut surfaces 125 may each form an angle α with respect to the longitudinal axis 103 of the shaft 105, as shown in FIG. 2D.

In some embodiments, the angle α may be greater than 90 degrees.

In some embodiments, the plurality of second undercut surfaces 112 and the plurality of sixth undercut surfaces 126 may each form an angle β with respect to the longitudinal axis 103 of the shaft 105.

In some embodiments, the angle β may be less than 90 degrees.

In some embodiments, the plurality of third undercut surfaces 113 and the plurality of seventh undercut surfaces 127 may each form an angle θ with respect to the longitudinal axis 103 of the shaft 105.

In some embodiments, the angle θ may be approximately 90 degrees.

In some embodiments, the angle θ may be greater than 90 degrees.

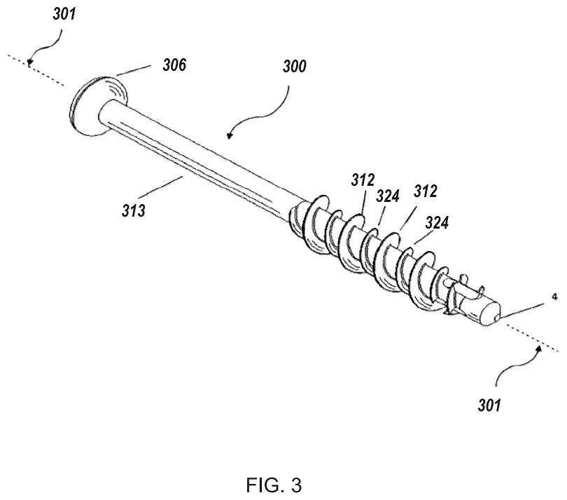

Referring FIG. 3, an example of the threaded fastener 1 of FIG. 1 is shown, and in particular, a fastener 300. The fastener 300 has an elongated shaft 313, substantially cylindrical along its length with a linear long axis 301 at its center. The screw may have a head 306 provided with a drive face on its top surface. The face can be contoured to accommodate a drive socket, screw driver tip, “torx” fitting, allen wrench, etc. to advance the screw.

A plurality of thread flights is contemplated, and the drawings illustrate a two flight embodiment. A first flight having a first thread 312 displays a greater crest diameter than a second flight having a second thread 324. In some examples, these two flights are spaced from each other by 180 degrees and enjoy the same pitch. As shown, thread 312 enjoys a greater crest diameter than thread 324.

In short, the present disclosure discusses fasteners, that in some examples, physically trap the adjacent substrate whether that be bone, metal, polymer, wood, drywall, ceramic, concrete, dirt, ice, stone, etc. The disclosure discusses using two or more leads to create interlocking patterns on screws, fasteners, nuts, bolts, inserts, threaded clips, dual-ended threaded studs or rods, taps, and in substrates (female threadform) to receive a mating component. The fastener geometries disclosed are generally cylindrical in length but could include either a tapered minor diameter, major diameter, or both. The geometries could be generated for use with a tap, could be designed to be self-tapping, or could be on a tap to prepare a substrate. The geometries disclosed are agnostic to material but all trap the adjacent material between threads based on undercut surfaces and geometry. The thread forms could be present on threaded fasteners/screws with or without heads, could be dual or multiple lead, could be on a bolt and/or a nut, an insert nut, a combination of a fastener or nut with these thread forms and a standard buttress thread form, a thread clip, threaded stud, thread screw or post with an overmold, or other embodiments. The thread forms could be present on a drill or tap instrument, or combination thereof. Any of these variations could have flat tips, pointed tips, self-tapping, could be cannulated or solid, partially, or fully thread, cylindrical or tapered, could have a fixed diameter, a variable diameter, or a consistent or varying pitch. Geometries with undercuts and surfaces that trap the adjacent substrate have demonstrated increased stability in multi-axial loading and resist loads both in tension and compression. Rather than relying on direct compression and radial loading of the substrate material, these designs interlock with the substrate as they are turned in, preserving the volume and integrity of the surrounding substrate for loading and load sharing. The dual lead designs disclosed within this document offer the opportunity to manufacturing these interlocking and undercut designs by traditional machining and turning, or by milling with form tools as the space created between two adjacent threads can alternate shapes and lend itself to form tooling.

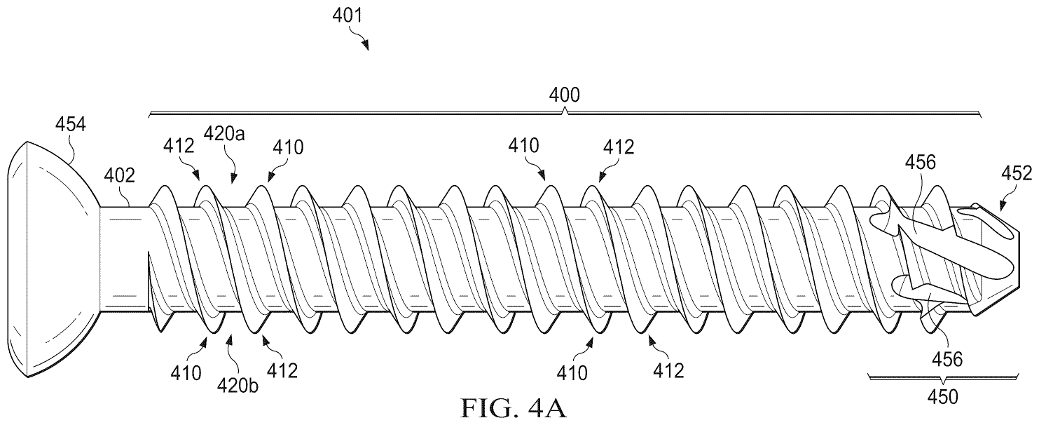

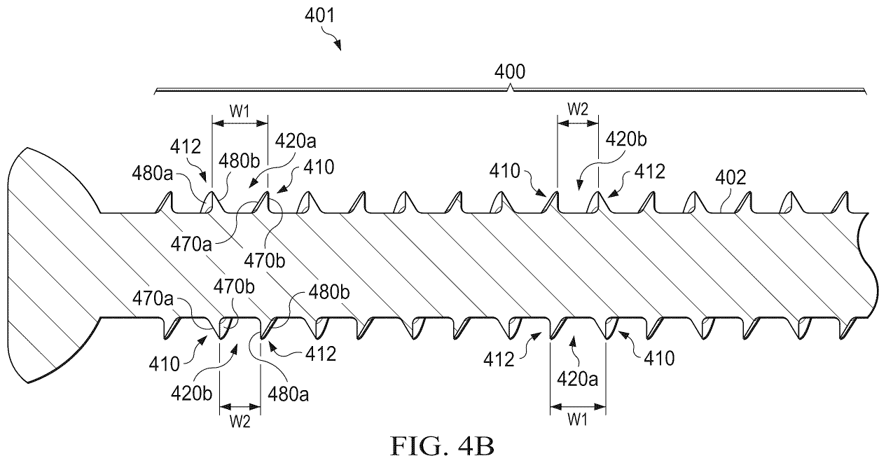

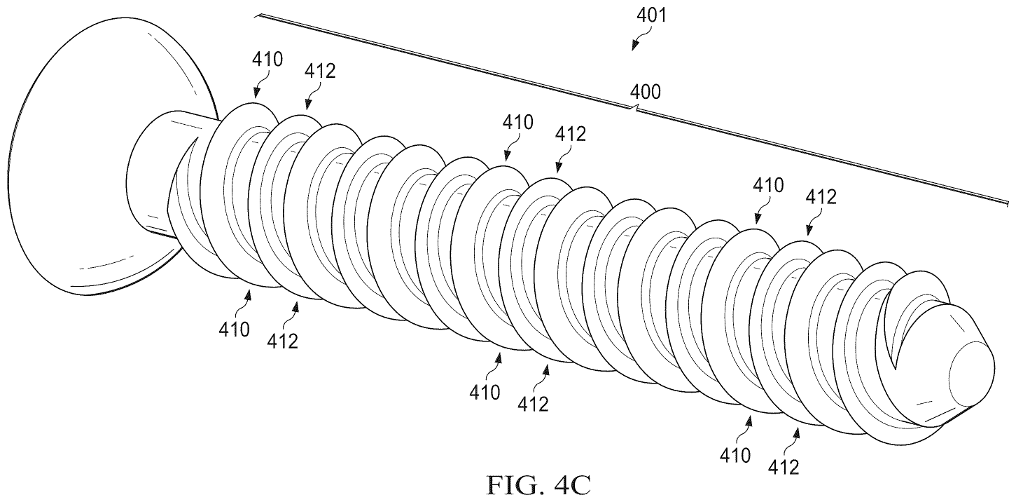

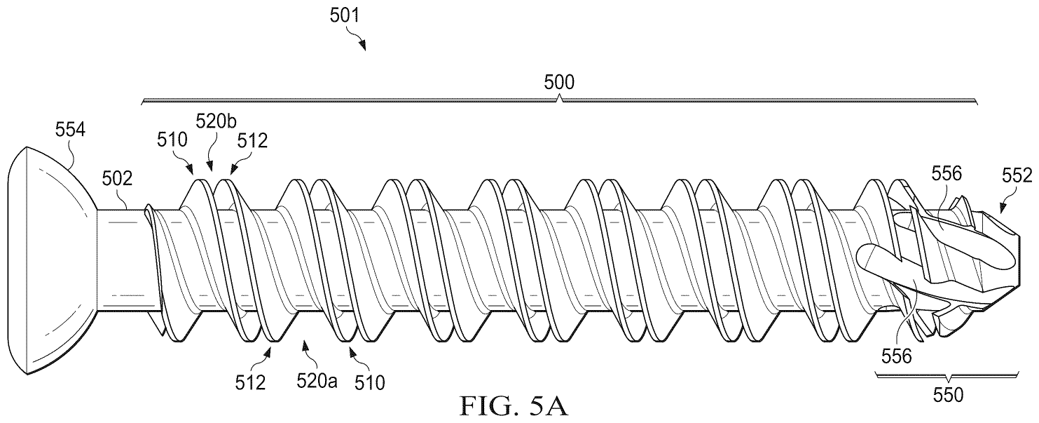

FIGS. 4A, 4B, 4C illustrate a thread pattern, in a first implementation, that can be implemented by the fasteners of FIGS. 1-3 (e.g., fastener 1, fastener 100, fastener 300), or any appropriate combination/arrangement of threads of FIGS. 1-3.

FIGS. 4A, 4B, 4C illustrate an example thread pattern 400 of a fastener 401, in a first implementation. Specifically, FIG. 4A illustrates a side view of the fastener 401; FIG. 4B illustrates a cutaway side view of the fastener 401; and FIG. 4C illustrates a perspective view of the fastener 401. The thread pattern 400 extends from a shaft 402 of the fastener 401 and the thread pattern 400 is of such a shape that the thread pattern 400 forms multiple thread faces that extend outward from the shaft 402, described further herein.

The thread pattern 400 can include a first thread pattern 410 and a second thread pattern 412. In some examples, the thread patterns 410, 412 are spaced from each other by 180 degrees (or substantially 180 degrees).

The first thread pattern 410 can include a top surface 470a and a bottom surface 470b. The top surface 470a is positioned opposite to the bottom surface 470b. The first thread pattern 410 extends from the shaft 402, and forms various angles with respect to the shaft 402, described further herein. The first thread pattern 410 can extend along at least a portion of the shaft 402.

The top surface 470a of the first thread pattern 410 forms a first angle with respect to the shaft 402. That is, the top surface 470a is “angled” with respect to the shaft 402; or, in other words, the top surface 470a is not normal to the shaft 402. In some examples, the top surface 470a of the first thread pattern 410 is angled with respect to the shaft 402 at 90 degrees or greater. In some examples, the top surface 470a of the first thread pattern 410 can be curved/rounded with the top surface 470a forming the first angle with respect to the shaft 402.

The bottom surface 470b of the first thread pattern 410 can be normal, or substantially normal, to the shaft 402. That is, the bottom surface 470b is “flat” with respect to the shaft 402; or, in other words, the bottom surface 470b is perpendicular to the shaft 402. In some examples, the bottom surface 470b of the first thread pattern 410 forms an angle of approximately 90 degrees with respect to the shaft 402. In some examples, the bottom surface 470b of the first thread pattern 410 can be curved/rounded with the bottom surface 470b being normal, or substantially normal, with respect to the shaft 402.

The second thread pattern 412 can include a top surface 480a and a bottom surface 480b. The top surface 480a is positioned opposite to the bottom surface 480b. The second thread pattern 412 extends from the shaft 402, and forms various angles with respect to the shaft 402, described further herein. The second thread pattern 412 can extend along at least a portion of the shaft 402.

The top surface 480a of the second thread pattern 412 can be normal, or substantially normal, to the shaft 402. That is, the top surface 480a is “flat” with respect to the shaft 402; or, in other words, the top surface 480a is perpendicular to the shaft 402. In some examples, the top surface 480a of the second thread pattern 412 forms an angle of approximately 90 degrees with respect to the shaft 402. In some examples, the top surface 480a of the second thread pattern 412 can be curved/rounded with the top surface 480a being normal, or substantially normal, with respect to the shaft 402.

The bottom surface 480b of the second thread pattern 412 forms a second angle with respect to the shaft 402. That is, the bottom surface 480b is “angled” with respect to the shaft 402; or, in other words, the bottom surface 480b is not normal to the shaft 402. In some examples, the bottom surface 480b of the second thread pattern 412 is angled with respect to the shaft 402 at 90 degrees or greater. In some examples, the bottom surface 480b of the second thread pattern 412 can be curved/rounded with the bottom surface 480b forming the second angle with respect to the shaft 402.

The first thread pattern 410 and the second thread pattern 412 can form valleys therebetween. Specifically, a valley 420a can be formed between the first thread pattern 410 and the second thread pattern 412, and in particular, between the top surface 470a of the first thread pattern 410 and the bottom surface 480b of the second thread pattern 412. That is, when the top surface 470a of the first thread pattern 410 and the bottom surface 480b of the second thread pattern 412 are adjacent to one another along the shaft 402, the top surface 470a of the first thread pattern 410 and the bottom surface 480b of the second thread pattern 412 define the valley 420a therebetween. That is, the valley 420a is formed between two surfaces that are angled with respect to the shaft 402—the top surface 470a of the first thread pattern 410 and the bottom surface 480b of the second thread pattern 412 are both angled with respect to the shaft 402. The valley 420a can have a first width W1.

Furthermore, a valley 420b can be formed between the first thread pattern 410 and the second thread pattern 412, and in particular, between the bottom surface 470b of the first thread pattern 410 and the top surface 480a of the second thread pattern 412. That is, when the bottom surface 470b of the first thread pattern 410 and the top surface 480a of the second thread pattern 412 are adjacent to one another along the shaft 402, the bottom surface 470b of the first thread pattern 410 and the top surface 480a of the second thread pattern 412 define the valley 420b therebetween. That is, the valley 420b is formed between two surfaces that are normal, or substantially normal, with respect to the shaft 402—the bottom surface 470b of the first thread pattern 410 and the top surface 480a of the second thread pattern 412 are both normal, or substantially normal, with respect to the shaft 402. The valley 420b can have a second width W2. In some examples, the first width W1 of the valley 420a is greater than the second width of the valley 420b.

To that end, the unique thread pattern/geometry of thread pattern 400, and the first thread pattern 410 and the second thread pattern 412 including the valleys 420a and 420b that are defined by the first thread pattern 410 and the second thread pattern 412, provide the fastener 401 to have an increased resistance to loads in all directions, allow for increased clamping forces, and increased resistance to pullout. Additionally, the fastener 401 allows for linear motion along the axis of the fastener 401 with the valleys 420a facilitating a reduction in the force necessitated to move a coupled object along the fastener 401; and the valleys 420b facilitating linear resistance to motion when the fastener 401 is not turning (stationary).

In some examples, the fastener 401 can include a self-tapping portion 450 positioned at a distal end 452 of the fastener 401 from a head 454 of the fastener 401. As illustrated, the self-tapping portion 450 can include multiple cutting flutes 456; however, the self-tapping portion 450 can include any number of cutting flutes. In some examples, the fastener 401 does not include the self-tapping portion 450.

In some examples, the thread pattern 400 extends partially along the shaft 402—that is, only a portion of the shaft 402 includes the thread pattern 400 (e.g., bolt configuration). In some examples, the fastener 401 can have a blind mate, or be coupled with a nut (not shown) that attaches/couples to the thread pattern 400.

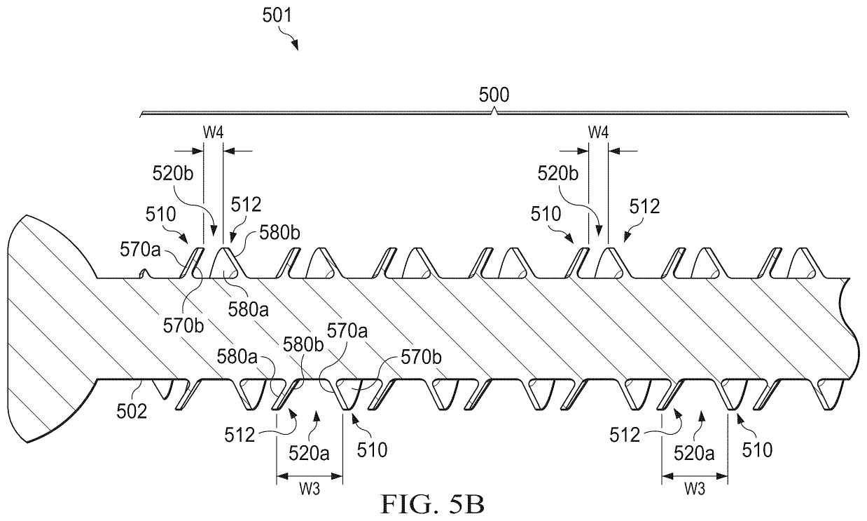

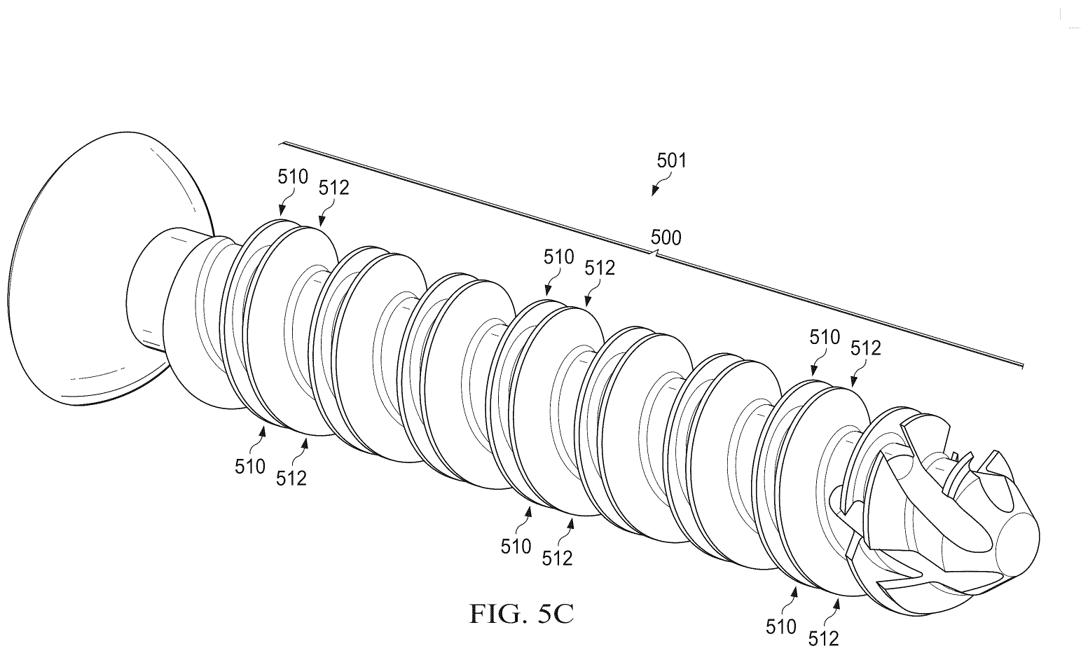

FIGS. 5A, 5B, 5C illustrate a thread pattern, in a second implementation, that can be implemented by the fasteners of FIGS. 1-3 (e.g., fastener 1, fastener 100, fastener 300), or any appropriate combination/arrangement of threads of FIGS. 1-3.

FIGS. 5A, 5B, 5C illustrate an example thread pattern 500 of a fastener 501, in a second implementation. Specifically, FIG. 5A illustrates a side view of the fastener 501; FIG. 5B illustrates a cutaway side view of the fastener 501; and FIG. 5C illustrates a perspective view of the fastener 501. The thread pattern 500 extends from a shaft 502 of the fastener 501, and the thread pattern 500 is of such a shape that the thread pattern 500 forms multiple thread faces that extend outward from the shaft 502, described further herein.

The thread pattern 500 can include a first thread pattern 510 and a second thread pattern 512. In some examples, the thread patterns 510, 512 are spaced from each other by 180 degrees (or substantially 180 degrees).

The first thread pattern 510 can include a top surface 570a and a bottom surface 570b. The top surface 570a is positioned opposite to the bottom surface 570b. The first thread pattern 510 extends from the shaft 502, and forms various angles with respect to the shaft 402, described further herein. The first thread pattern 510 can extend along at least a portion of the shaft 502.

The top surface 570a of the first thread pattern 510 forms a first angle with respect to the shaft 502. That is, the top surface 570a is “angled” with respect to the shaft 502; or, in other words, the top surface 570a is not normal to the shaft 502. In some examples, the top surface 570a of the first thread pattern 510 is angled with respect to the shaft 502 at 90 degrees or greater. In some examples, the top surface 570a of the first thread pattern 510 can be curved/rounded with the top surface 570a forming the first angle with respect to the shaft 502.

The bottom surface 570b of the first thread pattern 510 forms a second angle with respect to the shaft 502. That is, the bottom surface 570b is “angled” with respect to the shaft 502; or, in other words, the bottom surface 570b is not normal to the shaft 502. In some examples, the bottom surface 570b of the first thread pattern 510 is angled with respect to the shaft 502 at 90 degrees or less. In some examples, the bottom surface 570b of the first thread pattern 510 can be curved/rounded with the bottom surface 570b forming the second angle with respect to the shaft 502.

The second thread pattern 512 can include a top surface 580a and a bottom surface 580b. The top surface 580a is positioned opposite to the bottom surface 580b. The second thread pattern 512 extends from the shaft 502, and forms various angles with respect to the shaft 502, described further herein. The second thread pattern 512 can extend along at least a portion of the shaft 502.

The top surface 580a of the second thread pattern 512 forms a third angle with respect to the shaft 402. That is, the top surface 580a is “angled” with respect to the shaft 502; or, in other words, the top surface 580a is not normal to the shaft 502. In some examples, the top surface 580a of the second thread pattern 512 is angled with respect to the shaft 502 at 90 degrees or less. In some examples, the top surface 580a of the second thread pattern 512 can be curved/rounded with the top surface 580a forming the third angle with respect to the shaft 502. In some examples, the third angle formed by the top surface 580a of the second thread pattern 512 is the same, or substantially the same, as the second angle formed by the bottom surface 570b of the first thread pattern 510.

The bottom surface 580b of the second thread pattern 512 forms a fourth angle with respect to the shaft 502. That is, the bottom surface 580b is “angled” with respect to the shaft 502; or, in other words, the bottom surface 580b is not normal to the shaft 502. In some examples, the bottom surface 580b of the second thread pattern 512 is angled with respect to the shaft 502 at 90 degrees or greater. In some examples, the bottom surface 580b of the second thread pattern 512 can be curved/rounded with the bottom surface 580b forming the fourth angle with respect to the shaft 502. In some examples, the fourth angle formed by the bottom surface 580b of the second thread pattern 512 is the same, or substantially the same, as the first angle formed by the top surface 570a of the first thread pattern 510.

The first thread pattern 510 and the second thread pattern 512 can form valleys therebetween. Specifically, a valley 520a can be formed between the first thread pattern 510 and the second thread pattern 512, and in particular, between the top surface 570a of the first thread pattern 510 and the bottom surface 580b of the second thread pattern 512. That is, when the top surface 570a of the first thread pattern 510 and the bottom surface 580b of the second thread pattern 512 are adjacent to one another along the shaft 502, the top surface 570a of the first thread pattern 510 and the bottom surface 580b of the second thread pattern 512 define the valley 520a therebetween. That is, the valley 520a is formed between two surfaces that are angled greater than 90 degrees with respect to the shaft 502—the top surface 570a of the first thread pattern 510 and the bottom surface 580b of the second thread pattern 512 are both angled greater than 90 degrees with respect to the shaft 502.

Furthermore, a valley 520b can be formed between the first thread pattern 510 and the second thread pattern 512, and in particular, between the bottom surface 570b of the first thread pattern 510 and the top surface 580a of the second thread pattern 512. That is, when the bottom surface 570b of the first thread pattern 510 and the top surface 580a of the second thread pattern 512 are adjacent to one another along the shaft 502, the bottom surface 570b of the first thread pattern 510 and the top surface 580a of the second thread pattern 512 define the valley 520b therebetween. That is, the valley 520b is formed between two surfaces that are angled less than 90 degrees with respect to the shaft 502—the bottom surface 570b of the first thread pattern 510 and the top surface 580a of the second thread pattern 512 are both angled less than 90 degrees with respect to the shaft 502.

To that end, the unique thread pattern/geometry of thread pattern 500, and the first thread pattern 510 and the second thread pattern 512 including the valleys 520a and 520b that are defined by the first thread pattern 510 and the second thread pattern 512, provide the fastener 501 to have an increased resistance to loads in all directions, allow for increased clamping forces, and increased resistance to pullout. Additionally, the fastener 501 allows for linear motion along the axis of the fastener 501 with the valleys 520a facilitating a reduction in the force necessitated to move a coupled object along the fastener 501; and the valleys 520b facilitating linear resistance to motion when the fastener 501 is not turning (stationary).

In some examples, the fastener 501 can include a self-tapping portion 550 positioned at a distal end 552 of the fastener 501 from a head 554 of the fastener 501. As illustrated, the self-tapping portion 550 can include multiple cutting flutes 556; however, the self-tapping portion 550 can include any number of cutting flutes. In some examples, the fastener 501 does not include the self-tapping portion 550.

In some examples, the thread pattern 500 extends partially along the shaft 502—that is, only a portion of the shaft 502 includes the thread pattern 500 (e.g., bolt configuration). In some examples, the fastener 501 can have a blind mate, or be coupled with a nut (not shown) that attaches/couples to the thread pattern 500.

Any of the thread patterns and threads may be combined in any combination to form any variation of the fasteners.

In some further implementations, any of the fasteners (e.g., any of fastener 1, fastener 100, fastener 300, fastener 401, fastener 501) described herein having any of the thread patterns described herein can be manufactured using one or more of cold heading/forming, milling, machining, molding, additive material (3-D Printing), flat, planetary or round external thread rolling dies, spiral welding, or investment casting. Any of the fasteners (e.g., any of fastener 1, fastener 100, fastener 300, fastener 401, fastener 501) described herein having any of the thread patterns described herein can be formed of such materials as metals (aluminum, steel, nickel, titanium, etc.), metal alloys, plastics and polymers (polyethylene, polypropylene, polycarbonate, etc.), ceramics, or composite materials. Any of the fasteners (e.g., any of fastener 1, fastener 100, fastener 300, fastener 401, fastener 501) described herein having any of the thread patterns described herein can have any of the features including flat tip, pointed tip, self-tapping tip, cannulation, head, no head, buttress threaded insert, locking nut, partially threaded bolt, dual/tri/quad chevron-shape threads, concave threads, convex threads, fixed major diameter, variable major diameter, or various pitch thread forms. Any of the fasteners (e.g., any of fastener 1, fastener 100, fastener 300, fastener 401, fastener 501) described herein having any of the thread patterns described herein can be used in substrates such as bone, stone, ice, metal or metal alloys, wood, composites, ceramic, plastic, concrete, fibrous or woven, polymer or plastic.

Any of the fasteners (e.g., any of fastener 1, fastener 100, fastener 300, fastener 401, fastener 501) described herein having any of the thread patterns described herein can be used in such implementations as a threaded fastener: single and dual threaded fastener with and without tapping; headless threaded fastener: single and dual threaded fastener with and without tapping; bolt and nut: single and dual threaded fastener; insert nut: outside fastener, inside standard or metric; tapping bit: single and dual threaded fastener to tap solid material; threaded clip; double ended threaded stud for soft materials: single threaded fastener on one end, standard or metric thread on other; threaded screw with post for over molding; and drill bit for round holes in metal, plastic, concrete, wood, composite, or multi-material.

In a use case, the fasteners 401, 501 can be implemented in a repair situation where a primary fastener may have failed, and the fasteners 401, 501 can be implemented directly into the existing hole vacated by the primary fastener.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A fastener including:
a shaft;
a first thread pattern extending from the surface, the first thread pattern including a first top surface and a first bottom surface, wherein the first top surface is angled with respect to the shaft, wherein the first bottom surface is normal to the shaft; and
a second thread pattern extending from the surface, the second thread pattern including a second top surface and a second bottom surface, wherein the second top surface is normal to the shaft and the second bottom surface is angled with respect to the shaft,
wherein the first top surface of the first thread pattern and the second bottom surface of the second thread pattern form a first valley therebetween,
wherein the first bottom surface of the first thread pattern and the second top surface of the second thread pattern form a second valley therebetween.

2. The fastener of claim 1, wherein
the first top surface of the first thread pattern is angled with respect to the shaft at a first angle,
the second bottom surface of the second thread pattern is angled with respect to the shaft at a second angle.

3. The fastener of claim 2, wherein the first angle and the second angle are the same angle.

4. The fastener of claim 2, wherein the first angle and the second angle are both greater than 90 degrees.

5. The fastener of claim 1, wherein the first valley is associated with a first width, and the second valley is associated with a second width.

6. The fastener of claim 5, wherein the first width is greater than the second width.

7. The fastener of claim 1, wherein the first top surface of the first thread pattern is adjacent to the second bottom surface of the second thread pattern.

8. The fastener of claim 1, wherein the first bottom surface of the first thread pattern is adjacent to the second top surface of the second thread pattern.

9. A fastener including:
a shaft;
a first thread pattern extending from the surface, the first thread pattern including a first top surface and a first bottom surface, wherein the first top surface is angled with respect to the shaft, wherein the first bottom surface is angled with respect to the shaft; and
a second thread pattern extending from the surface, the second thread pattern including a second top surface and a second bottom surface, wherein the second top surface is angled with respect to the shaft and the second bottom surface is angled with respect to the shaft,
wherein the first top surface of the first thread pattern and the second bottom surface of the second thread pattern form a first valley therebetween,
wherein the first bottom surface of the first thread pattern and the second top surface of the second thread pattern form a second valley therebetween.

10. The fastener of claim 9, wherein
the first top surface of the first thread pattern is angled with respect to the shaft at a first angle,
the first bottom surface of the first thread pattern is angled with respect to the shaft at a second angle,
the second top surface of the second thread pattern is angled with respect to the shaft at a third angle,
the second bottom surface of the second thread pattern is angled with respect to the shaft at a fourth angle.

11. The fastener of claim 10, wherein the first angle and the fourth angle are the same angle.

12. The fastener of claim 10, wherein the first angle and the fourth angle are both greater than 90 degrees.

13. The fastener of claim 10, wherein the second angle and the third angle are the same angle.

14. The fastener of claim 10, wherein the second angle and the third angle are both less than 90 degrees.

15. The fastener of claim 10, wherein the first valley is associated with a first width, and the second valley is associated with a second width.

16. The fastener of claim 15, wherein the first width is greater than the second width.

17. The fastener of claim 10, wherein the first top surface of the first thread pattern is adjacent to the second bottom surface of the second thread pattern.

18. The fastener of claim 10, wherein the first bottom surface of the first thread pattern is adjacent to the second top surface of the second thread pattern.
